(19) United States
(12) Patent Application Publication
(10) Pub. No.: US 2026/0105112 A1
(43) Pub. Date: Apr. 16, 2026

(54) SYSTEMS AND METHODS FOR MACHINE LEARNING ASSISTED USER TRAINING OF DEVICE CONTROLS

(71) Applicant: Afaf Saleh, Dryden, MI (US)

(72) Inventor: Afaf Saleh, Dryden, MI (US)

(73) Assignee: ENGIDYNAMICS, LLC, Dryden, MI (US)

(21) Appl. No.: 19/356,076

(22) Filed: Oct. 11, 2025

Related U.S. Application Data
(60) Provisional application No. 63/706,110, filed on Oct. 11, 2024.
(60) Provisional application No. 63/762,778, filed on Feb. 25, 2025.

(51) Int. Cl. G06F 16/9538; G06F 3/16; G06F 16/9032; G06F 16/9532; G06F 16/9535; G06T 11/00

(52) U.S. Cl. CPC G06F 16/9538; G06F 3/167; G06F 16/90324; G06F 16/9532; G06F 16/9535; G06T 11/00

(57) ABSTRACT

In some implementations, the device may receive a vehicle ID from the user based on the vehicle. Additionally, the device may receive from the user a first query and a first image of the vehicle control. The device may receive from the user device first contextual information based on the real-time status of the user, the user device, the vehicle, and the user's environment. Moreover, the device may include generating a first prompt based on the vehicle ID, the first query, the first image of the vehicle control, and the first contextual information. Additionally, the device may receive a first text response and a first image response from an MLM, where the first image response may include modifying the first image of the vehicle control based on the first prompt. Furthermore, the device may display to the user the first text response and the first image response.

### CROSS-REFERENCE TO RELATED APPLICATIONS

This application claims the benefit under 35 U.S.C. § 119(e) of the following prior filed U.S. Provisional Patent Applications: U.S. Provisional Patent Application No. 63/706,110, filed on Oct. 11, 2024; and U.S. Provisional Ser. No. 63/762,778, filed on Feb. 25, 2025; the disclosures of these applications are each incorporated herein by reference in their entirety. Furthermore, all publications, patent applications, patents, and other references mentioned in this application are herein incorporated by reference to the same extent as if each individual publication, patent application, patent, or other reference was specifically and individually indicated to be incorporated by reference, provided that in case of conflict between the terms incorporated by reference and the terms of this application, the terms of this application shall control.

### TECHNICAL FIELD

The present technology relates to systems and applications and, more particularly, to an interactive system configured to enhance a user understanding of a functionality of an electronic system or device.

### BACKGROUND

This section provides background information related to the present disclosure, which is not necessarily prior art.

Certain electronic systems, such as those within a vehicle or transportation device, a medical device, a smart home device, an appliance, and other technology-equipped devices, may be embedded with buttons, icons, and images, each designed to a perform specific function. For example, modern vehicles, medical devices, home automation systems, and various consumer electronics increasingly rely on dashboard indicators, digital icons, LED symbols, and other visual notifications to communicate status, alerts, and operational information. In the automotive sector, dashboard warning lights provide critical information regarding engine status, tire pressure, battery life, and other system diagnostics. Similarly, medical devices such as patient monitors and home health equipment utilize visual indicators to signal warnings, device status, or necessary maintenance actions. Consumer appliances, including smart thermostats, washing machines, and security systems, also employ digital icons and LED indicators to facilitate user interaction. However, the complexity of the interface and the icons or buttons may overwhelm a user, particularly a user unfamiliar with the specific device and an operation of the device. This may lead to an underutilization of available features of the electronic device or system, as a user may be hesitant to explore a functionality or operability of a button or icon that is not understood.

A physical manual or digital guide may provide an explanation for the various controls and indicators of these devices and systems. However, such resources may be cumbersome and non-user-friendly, especially when a user needs immediate information. The static nature of a printed manual or digital guide may not allow a user to access information immediately or as needed, as a user is interacting with the electronic device and/or system. Such static references source may also be limited with respect to any later updates, corrections, or additions. Physical manuals may also be lost or misplaced by the previous owner or be kept in an area not familiar to the user.

Other smart phone diagnostic applications may be limited in accessibility and scope of device compatibility. Accessing diagnostic or status information from vehicles and other devices often requires proprietary hardware connections, such as an onboard diagnostics (OBD-II) interface for automobiles, Bluetooth-enabled communication, or specialized applications tailored to a single device type. These methods present several limitations, including the necessity of hardware compatibility, reliance on manufacturer-specific applications, and the inability to function across different types of devices or older systems that lack connectivity features. For example, other diagnostic applications for smart phones may not be compatibl with older vehicle models that do not have Bluetooth integration with the dashboard, or with devices that do not include wireless or Bluetooth capabilities. Further, the user may be required to obtain the proprietary hardware connections such as an OBD-II and may need to transfer these additional devices to each vehicle they drive. While diagnostic hardware may be available for vehicle diagnostics, this proprietary hardware may not be available for all medical devices, home devices, consumer appliances.

Certain attempts to integrate a tutorial system directly with the electronic device or system, such as in-built help-system, or query look-up device may be helpful but still may require a user to navigate through multiple menus and may distract a user in their attempt to complete a primary task. In particular, such devices and systems may not provide a way to quickly identify and understand an icon and/or a button encountered by the user. While a mobile application may aid in understanding the features of various electronic systems, such a mobile application may require manual input of data or a search query and may not be tailored to recognize and explain specific icons and buttons of different devices and systems.

### SUMMARY

Accordingly, there is a continuing need for an intuitive, real-time method and system that may assist a user to utilize a full range of functionalities, and to provide contextual information about a control directly in response to a user query or input, thereby enhancing user experience and operational safety.

In concordance with the instant disclosure, an intuitive, real-time method and system that may assist a user to utilize a full range of functionalities, and to provide contextual information about a control directly in response to a user query or input, thereby enhancing user experience and operational safety, has surprisingly been discovered.

The present technology includes articles of manufacture, systems, and processes that relate to an interactive tool configured to facilitate an understanding and an operation of electronic systems across various devices, including vehicles, such as an all-terrain vehicle (ATV), an off-road vehicle (ORV), a boat, trucks, medical equipment, home systems, home appliances, and other appropriately desired vehicles and electronic devices.

In certain embodiments, a system for assisting a user in understanding a functionality of an electronic system may be used in conjunction with an image capture device and may include an application installed on the image capture device, a database, an image recognition module, and a display. The image capture device may be configured to capture an image of an icon or button of the electronic system. The application installed on the image capture device may be configured to receive the image from the image capture device. The database may be stored on the image capture device and/or be configured to be accessed by the image capture device through a network. The database may be in communication with the application and the database may include stored information related to the functionality of the electronic system. The image recognition module may be configured to compare and match the image to the stored information related to the functionality of the electronic system of the database and provide matched information. The display may be in communication with the image recognition module and configured to show the matched information.

In certain embodiments, the system may include an artificial intelligence (AI) module. The AI module may be configured to receive the matched information from the image recognition module, analyze the matched information, and provide output relating to the analysis of the matched information. The AI module may also be configured to receive the stored information from the database, analyze the matched information and stored information, and provide output relating to the analysis of the matched information and stored information. The AI module may provide output relating to the analysis of the matched information and stored information as a chatbot. For example, the AI module may provide output to the display in the form of a menu-based chatbot, an AI-powered chatbot, a voice chatbot, or a rule-based chatbot.

In certain embodiments, a method for assisting a user in understanding a functionality of an electronic system is provided. The method may include the step of providing a database in communication with the application, the database including stored information relating to the functionality of the electronic system. The method may include the step of capturing an image of a functionality of the electronic system using an image capture device. The method may include the step of receiving the image by an application installed on the image capture device. The method may include the step of comparing and matching the image to the stored information relating to the functionality of the electronic system of the database using an image recognition module to provide matched information. The method may include the step of displaying the matched information using a display in communication with the image recognition module.

In certain embodiments, a method for assisting a user in understanding a functionality of an electronic system is provided. The method may include the step of providing a database in communication with the application, the database including stored information relating to the functionality of the electronic system. The method may include the step of providing an artificial intelligence (AI) module configured to receive the matched information from the image recognition module, receive the stored information from the database, analyze the matched information and stored information, and provide output relating to the analysis of the matched information and stored information. The method may include the step of capturing an image of a functionality of the electronic system using an image capture device. The method may include the step of receiving the image by an application installed on the image capture device. The method may include the step of comparing and matching the image to the stored information relating to the functionality of the electronic system of the database using an image recognition module to provide matched information. The method may include the step of receiving the matched information and stored information via the AI module. The method may include the step of analyzing the matched information and stored information via the AI module. The method may include the step of displaying output on a display relating to the analysis of the matched information and stored information.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, the method may include receiving from the user, via a user device, a vehicle ID based on the vehicle. The method may also include receiving from the user a first query and a first image of the vehicle control. The method may furthermore include receiving from the user device a first contextual information based on a real-time status of the user, the user device, the vehicle, and an environment of the user. The method may, in addition, include generating a first prompt based on the vehicle ID, the first query, the first image of the vehicle control, and the first contextual information. The method may moreover include receiving, based on the first prompt, from an MLM, a first text response and a first image response, where the first image response may include modifying the first image of the vehicle control based on the first prompt. The method may also include displaying to the user, via the user device, the first text response and the first image response. Other embodiments of this aspect include corresponding computer systems, apparatus, and computer programs recorded on one or more computer storage devices, each configured to perform the actions of the methods described herein.

### BRIEF DESCRIPTION OF THE DRAWINGS

Advantages of the present invention will be readily appreciated as the same becomes better understood by reference to the following detailed description when considered in connection with the accompanying drawings wherein:

FIG. 1 is a block diagram illustrating a system for assisting a user in understanding a functionality of an electronic system, according to an embodiment of the present disclosure;

FIG. 2 is a block diagram illustrating a system for assisting a user in understanding a functionality of an electronic system, according to an embodiment of the present disclosure;

FIGS. 3 through 15 are screenshots of an example embodiment of a user interface for an application for assisting a user in understanding a functionality of an electronic system, according to an embodiment of the present disclosure;

FIG. 16 is a photograph showing a series of icons and descriptions of the icons of a system and method for assisting a user in understanding a functionality of an electronic system, according to an embodiment of the present disclosure;

FIG. 17 is a flowchart illustrating an example process for assisting a user in understanding a functionality of an electronic system, according to an embodiment of the present disclosure;

FIG. 18 is a flowchart illustrating an example process for assisting a user in understanding a functionality of an electronic system, according to an embodiment of the present disclosure;

FIG. 19 is a flowchart illustrating an example process for assisting a user in understanding a functionality related to a control of an electronic system, according to an embodiment of the present disclosure;

FIG. 20 is a flowchart illustrating an example process for generating query recommendations for a user being assisted with understanding a functionality related to a control of an electronic system, according to an embodiment of the present disclosure;

FIG. 21 is a flowchart illustrating an example process for assisting a user in understanding a functionality related to a control of an electronic system with an augmented reality (AR) interface, according to an embodiment of the present disclosure;

FIG. 22 is a screenshot of an example embodiment of a user interface for providing suggested queries to assist a user in understanding a functionality of an electronic system, according to an embodiment of the present disclosure;

FIG. 23 is a screenshot of an example embodiment of a user interface for providing socially generated content to assist a user in understanding a functionality of an electronic system, according to an embodiment of the present disclosure; and

FIG. 24 is a screenshot of an example embodiment of a user interface for providing a community engagement leaderboard, according to an embodiment of the present disclosure.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The present technology is related to improving a user interaction with an electronic system by providing a real-time, intuitive interface that may simplify an identification and an understanding of various controls and functionalities, including buttons, and icons of the electronic system. This enhancement may increase an accessibility of the features of the system for a user and also promote a more pleasant and efficient use of the technology. Using visual recognition and contextual information delivery, the present technology may help minimize a learning curve associated with new and existing electronic systems. The present technology may also adapt to a specific configuration of an electronic system, enabling a user to receive accurate and relevant information. The present technology may provide identification and an understanding of various controls and functionalities without requiring a direct connection to the electronic system. Furthermore, the technology extends beyond automotive applications, enabling users to interpret LED signals and digital icons from a broad range of devices, including medical equipment and household appliances, regardless of whether they are equipped with smartphone applications.

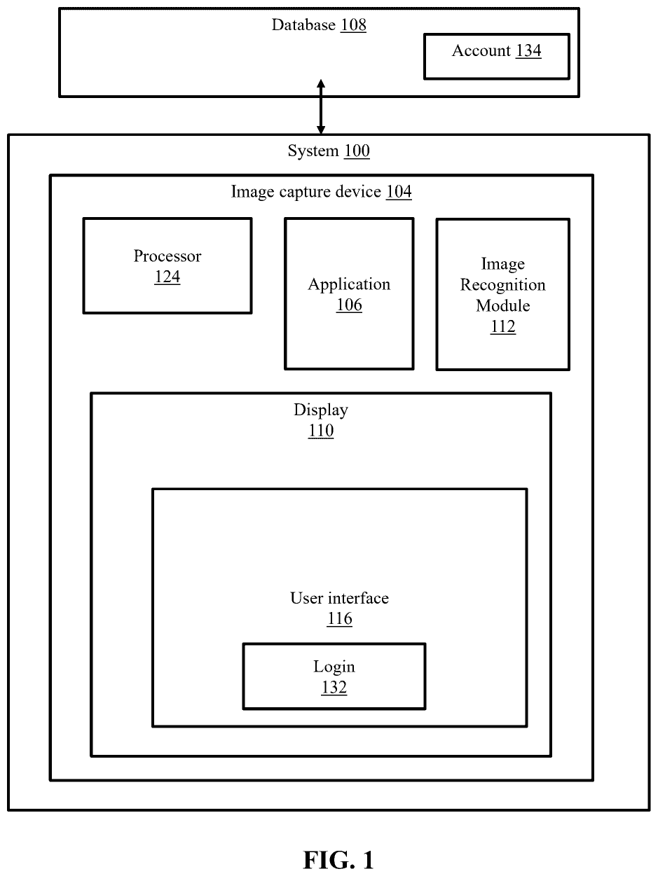

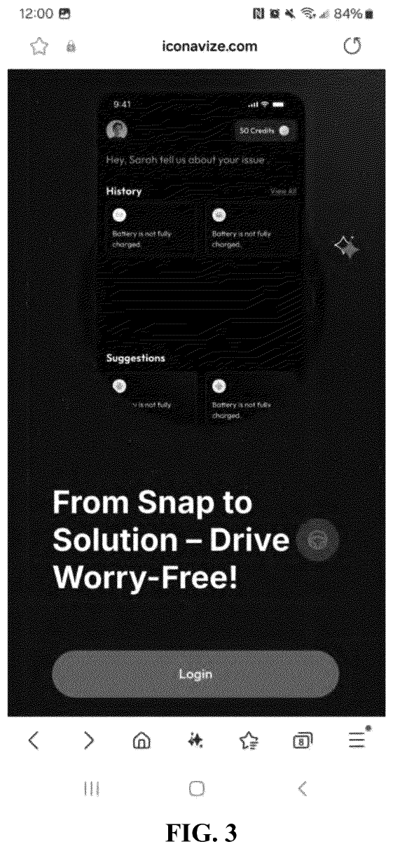

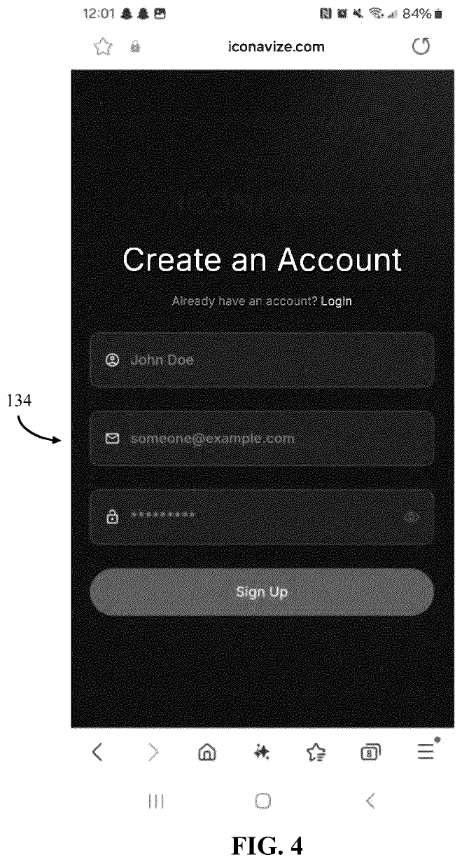

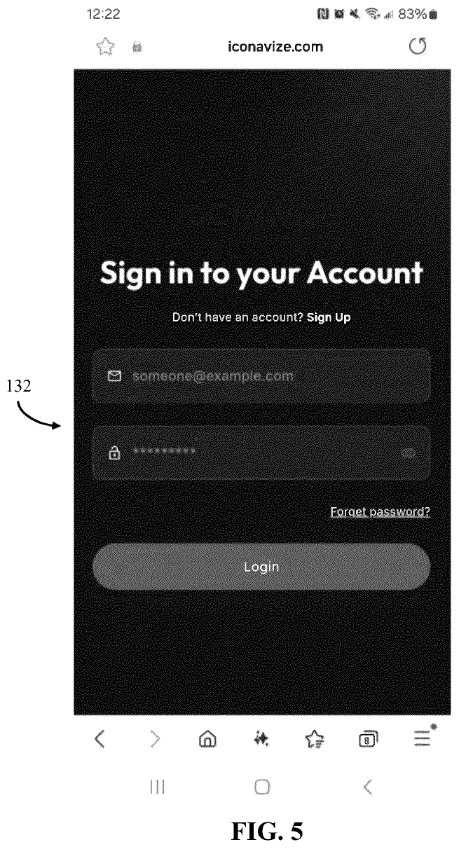

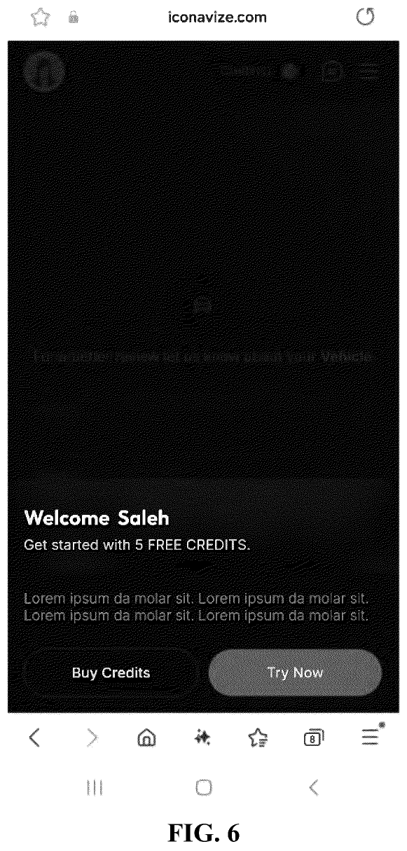

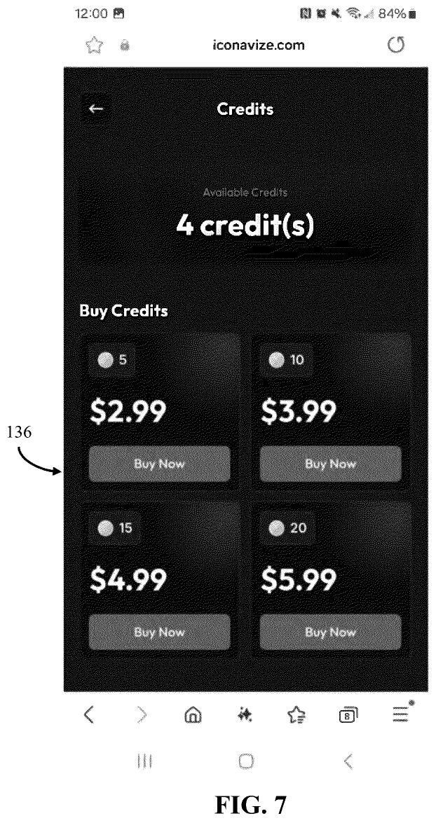

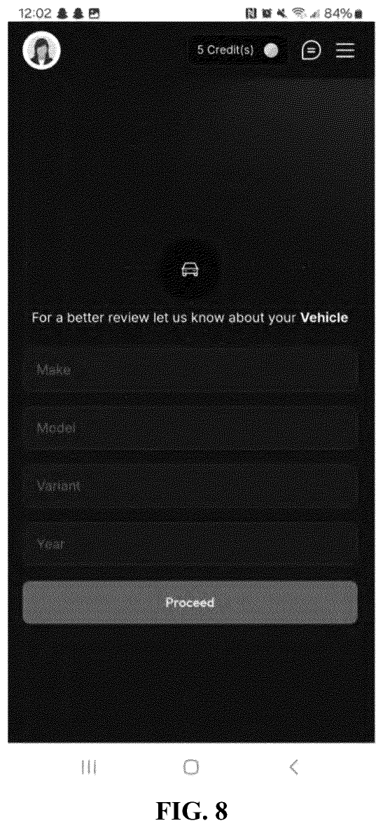

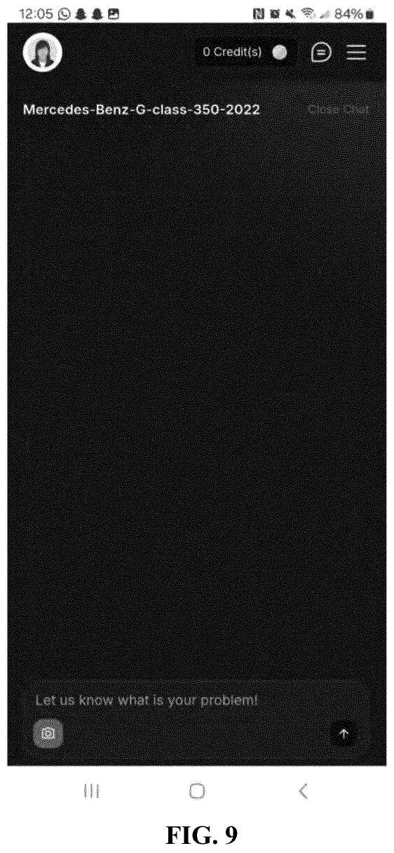

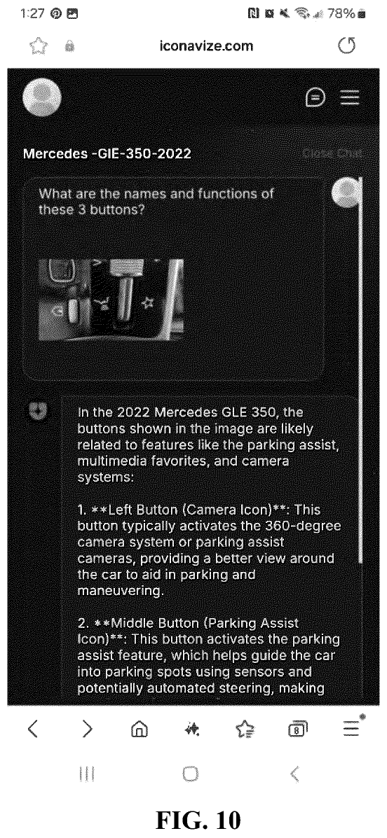

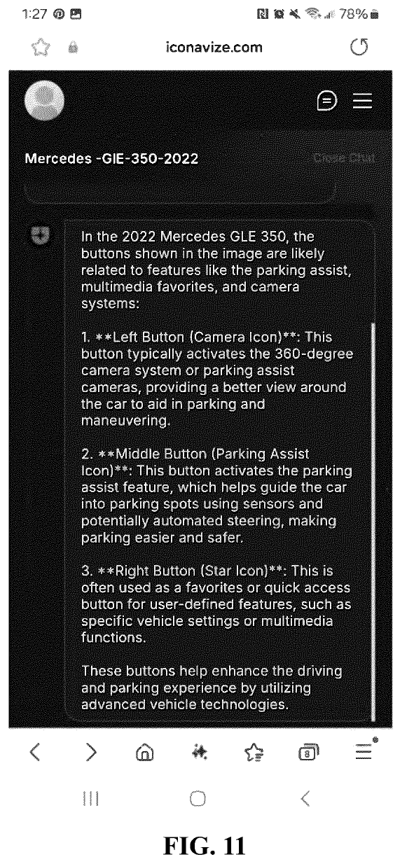

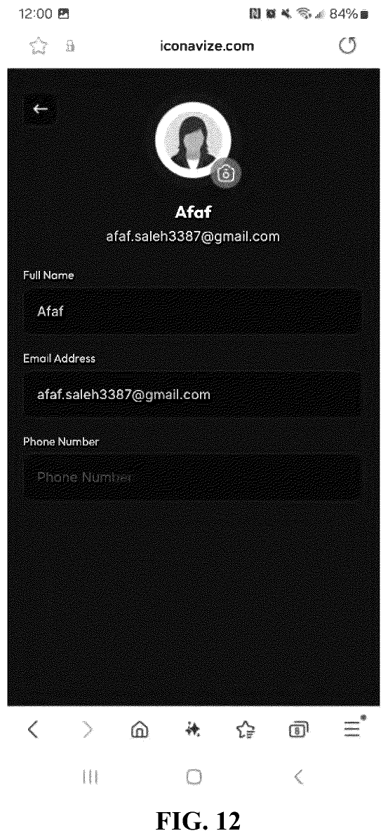

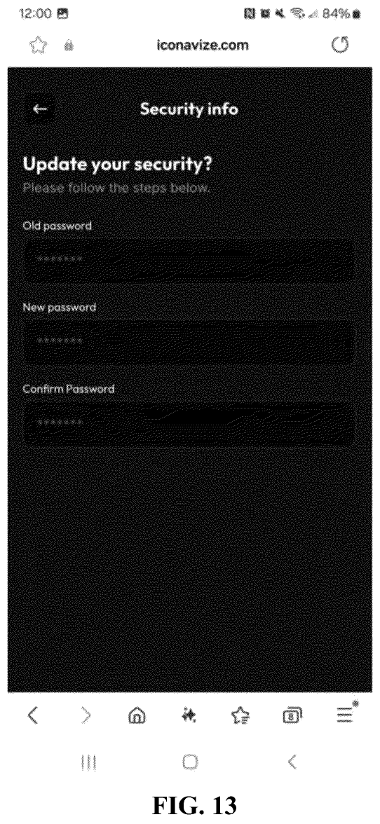

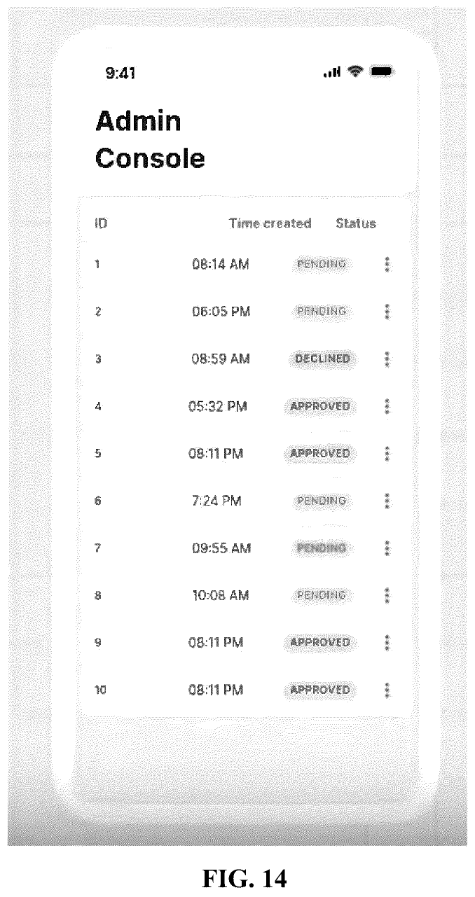

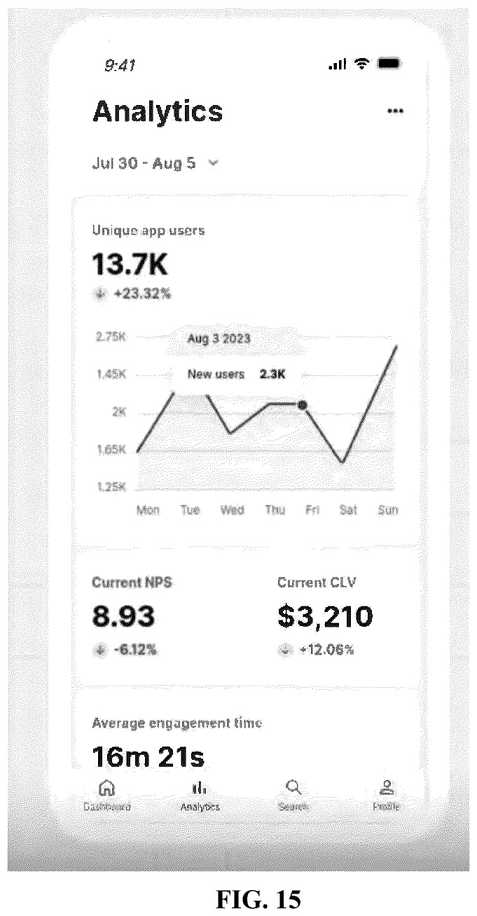

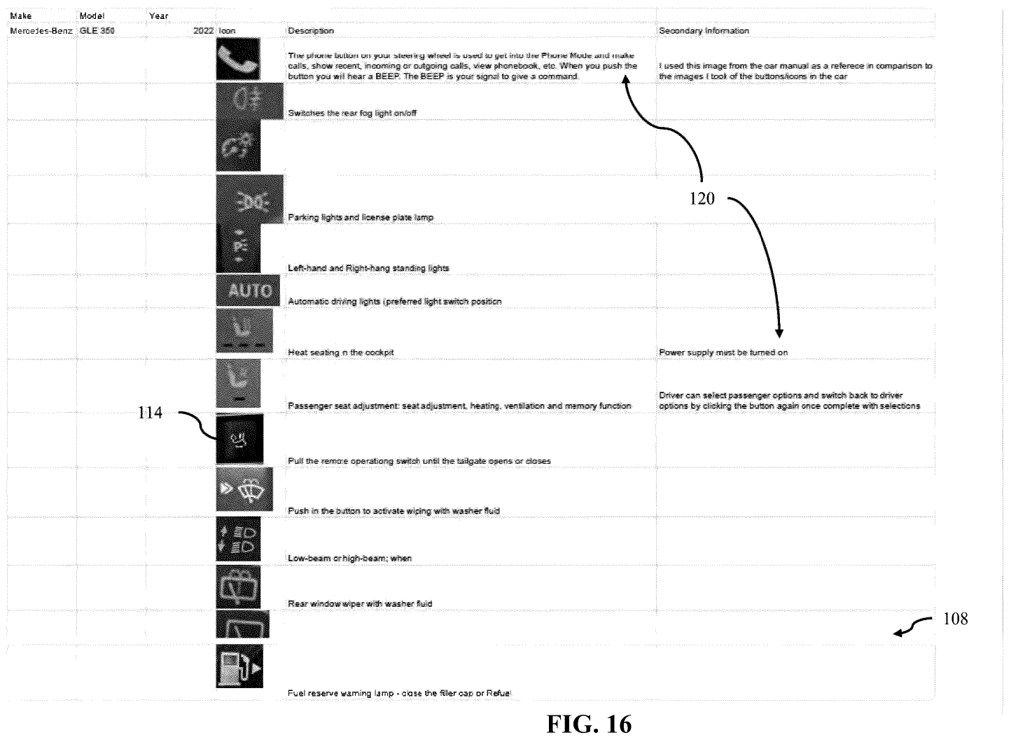

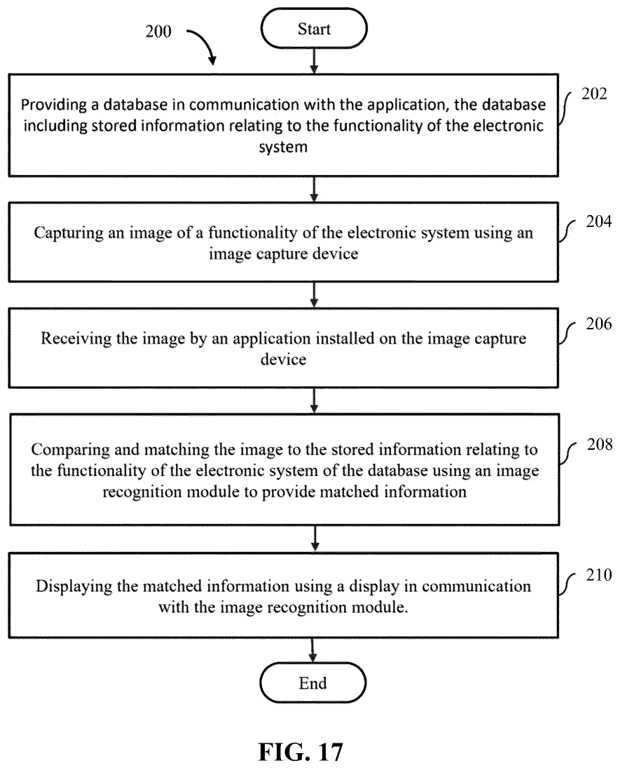

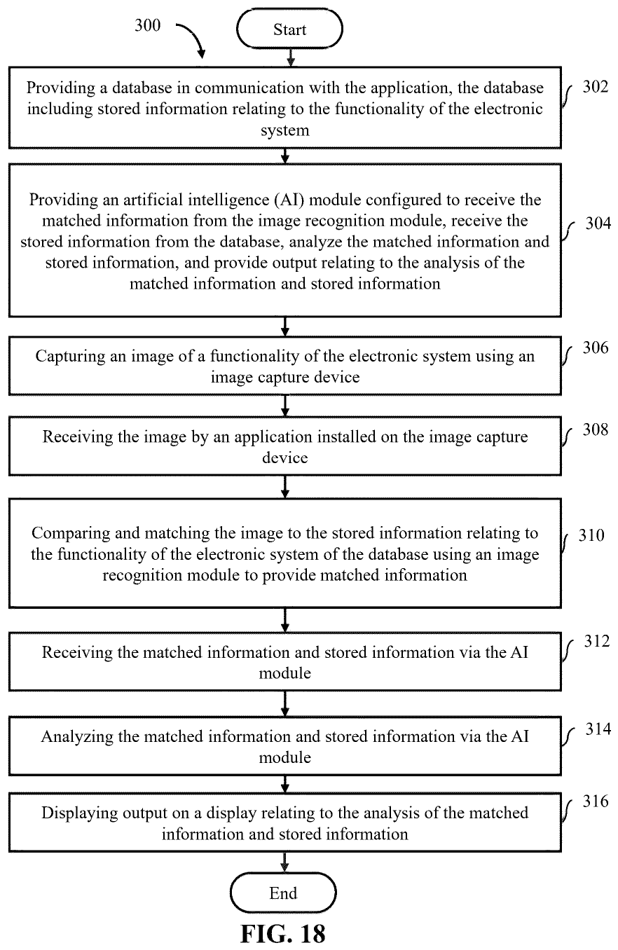

With reference now to the accompanying drawings, including FIGS. 1 through 18, certain aspects of a system 100 and methods 200 and 300 for assisting a user in understanding and operating an electronic device or the electronic system 102 are shown. FIGS. 1 through 16 show certain aspects of an application 106 for a system 100 for assisting a user in understanding and operating the electronic system 102. FIG. 17 shows a method 200 for assisting a user in understanding a functionality of an electronic system 102. FIG. 18 shows a method 300 for assisting a user in understanding a functionality of an electronic system 102.

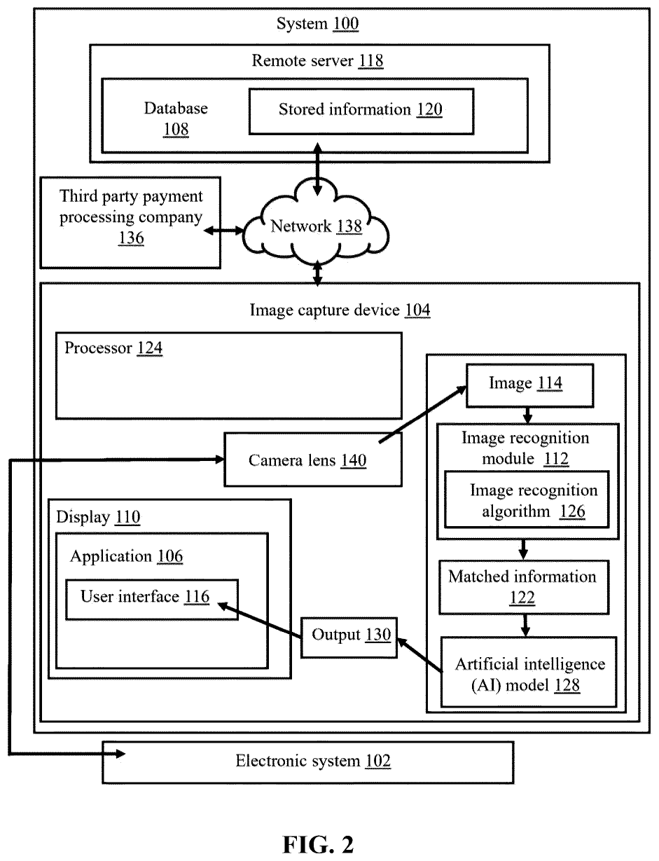

FIGS. 1 and 2 are block diagrams depicting aspects of a system 100 for assisting a user in understanding a functionality of an electronic system 102. The system 100 may include an image capture device 104, an application 106 installed on the image capture device 104, a database 108, and a display 110. The image capture device 104 may further include an image recognition module 112 configured to capture an image 114 of an icon or button of the electronic system 102 and a user interface 116. The application 106 installed on the image capture device 104 may be configured to receive an image 114 from the image capture device 104.

As shown in FIGS. 1 through 16, the database 108 may be stored on the image capture device 104. Alternatively, the database 108 may be stored on a remote server 118, for example through a cloud-based service, and configured to be accessed through a network 138. The database 108 may be in communication with the application 106 and may include the stored information 120 related to a functionality or a control of the electronic system 102. The image recognition module 112 may compare and match the icon or button to the database 108 where the display 110 may be configured to receive and present the stored information 120 corresponding to the matched information 122 stored within the database 108. The image recognition module 112 may be integrated into the application 106 or may be separate from the application 106. Likewise, the image recognition module 112 may be installed on the image capture device 104 or the image recognition module 112 may be configured to be accessed through a network 138 by the image capture device 104. The database 108 may be a relational database 108, such as SQL, a non-relational database 108 such as NoSQL, or document based, such as a spreadsheet. The database 108 may include prior images from the user, for example, user uploads, or images 114 preloaded for use by the application 106.

The electronic system 102 may be embedded within other electronic devices, such as a medical device, a smart home product, an appliance, and the like. The electronic system 102 may be embedded within a vehicle, truck, car, all-terrain vehicle (ATV), an off-road vehicle (ORV), a boat, trucks, medical equipment, home system, home appliance, and other appropriately desired vehicle and electronic device. In particular, the system 100 may be configured to communicate with and capture an image 114 or icon from any appropriately desired electronic device where the user may desire more information. For example, the electronic device or system may include a vehicle infotainment system, a vehicle climate control system, and a vehicle navigation system. The electronic device and/or system may also include a smart home thermostat, a security system, a lighting, system, a speaker, a home appliance, and/or a medical device. The user interface 116 may enable a user to interact with the application 106 and/or specify a certain model and type of electronic device.

The image capture device 104 may be for example, a smartphone, tablet, laptop, camera, or any other device that is configured to capture an image 114.

In some embodiments, the processor 124, which may be any suitable type of processing device, may be operably coupled to a non-transitory computer-readable medium, such as the onboard memory of the image capture device 104. In some embodiments, the processor 124 may be utilized to execute instructions and perform operations based on data stored in the onboard memory of the image capture device 104. A non-transitory computer-readable medium is a storage device that may include, but is not limited to, a solid-state drive (SSD), a hard disk drive (HDD), flash memory, or random-access memory (RAM). Computer-executable instructions, data structures, and program modules may be stored on this medium. When the instructions are executed by the processor 124, the image capture device 104 may be caused to perform the described methods and functions. The term “non-transitory” emphasizes that the medium is not a temporary signal but a tangible, physical component capable of holding information permanently or semi-permanently, thereby satisfying the statutory requirements for patentable subject matter. This configuration may enable a stable and persistent environment for executing the software.

The image capture device 104 may include a camera lens 140 configured to capture an image 114. The image capture device 104 may also be configured to store the application 106. The image recognition module 112 may be executed with a processor 124 that may be configured to utilize an image recognition algorithm 126.

The image recognition algorithm 126 may be configured to identify the image 114 as an icon or the button of the electronic system 102. For example, the application 106 may provide audio feedback through a speaker or other appropriately desired mechanism in addition to a visual display of stored information 120 or matched information 122 on the display 110 based upon an identification of the icon or the button of the electronic system 102. In another example, the user interface 116 may enable a user to choose whether the user would like visual information, audio information, or both. The image recognition module 112 may be, for example, AMAZON REKOGNITION, GOOGLE CLOUD VISION, TENSORFLOW. JS, MICROSOFT AZURE COMPUTER VISION, IBM WATSON VISUAL RECOGNITION, or image recognition models of a similar nature. The image 114 provided to the image recognition module 112 may be used to train the image recognition algorithm 126 for fine tuning. For example, the image 114 may be used to train the image recognition algorithm 126 via image-to-JSON. The image recognition algorithm 126 may be trained via each image 114 uploaded by users or may be trained upon instances where the image recognition algorithm 126 cannot match the image 114 to the stored information 120 from the database 108. It should be appreciated that the image recognition algorithm 126 allows the system 100 to analyze visual indicators and provide real-time diagnostic or informational feedback to the user without depending on Bluetooth connectivity or OBD-II adapters, allowing users to access crucial information from any vehicle, including older vehicle models that lack smart connectivity.

The application 106 may update or query the database 108 at a predetermined time period for updated or changed stored information 120 based on an identified electronic device. In particular, the matched information 122 or stored information 120 of the display 110 may include instructions on how to use the icon or the button of the electronic system 102. The application 106 and user interface 116 may be configured to receive user feedback regarding the accuracy of the stored information 120 or matched information 122 provided.

The image 114 received from the image capture device 104 may be representative of an icon, a button, a symbol, an outline, or a signal, or any other information relating to a functionality of an electronic system 102. The image 114 may show a single icon or group of icons in order to contextualize the information relating to the functionality of the electronic system 102. For example, the icon, symbol, or signal may include a check engine light as a single symbol or may include a check engine light and an oil pressure light. The image 114 may be taken in daylight, or with no light, for example in the case of back-lit and light-emitting diode (LED) buttons, icons, or display.

The system 100 may include an artificial intelligence (AI) model 128. The AI model 128 may be configured to receive the matched information 122 from the image recognition module 112, analyze the matched information 122, and provide output 130 relating to the analysis of the matched information 122. The AI model 128 may also be configured to receive and analyze the stored information 120 from the database 108, receive and analyze the matched information 122, and provide output 130 relating to the analysis of the matched information 122 and stored information 120. The AI model 128 may provide output 130 relating to the analysis of the matched information 122 and stored information 120 as a chatbot. For example, the AI model 128 may provide output 130 to the display 110 in the form of a menu-based chatbot, an AI-powered chatbot, a voice chatbot, or a rule-based chatbot. The user may communicate with the AI model 128 to carry out conversation relating to the image 114, the stored information 120, the matched information 122 or other topics concerning a functionality of an electronic system 102. The AI model 128 may utilize, for example, large language models such as CHATGPT, COPILOT, GOOGLE GEMINI, OPENAI, META IP, CHARACTER. AI, or large language models of a similar nature. In some embodiments, the AI model 128 may include a multimodal language model (MLM) such as GOOGLE GEMINI, CHAT GPT-4o, CHAT GPT-4 with vision, CLAUDE 3 SONNET, OPUS, and other appropriate machine learning models which can interpret multiple kinds of information at the same time.

The system 100 may include a login 132 option for users. The login 132 option may allow the user to create an account 134 in order to save previous image uploads for future viewing. The system 100 may include a login 132 page that requests a user's name, email, password, and optional profile pictures or other aesthetic options. The system 100 may protect user privacy by collecting only the user's name and email, while using a secure third-party payment processing company 136 for user passwords and financial information. The account 134 may be stored on the database 108. Alternatively, the account 134 may be stored, for example, on a separate server, on the image capture device 104, or with a third-party service. It should be appreciated that utilizing a third-party payment processing company 136, the system 100 may provide added security to the user in instances of data breaches. For example, the password and financial information may be processed through a third-party payment processing company 136 such as Stripe. Additional security measures may be provided to the user, including encrypted communication between the system 100 and the user regarding the images 114 uploaded to the application 106, the communications made with the application 106 and the user via the chatbot, or the matched information 122 or output 130 from the AI model 128 provided to the user and/or stored on the database 108. It should also be appreciated that the images 114, matched information 122, or output 130 from the AI model 128 may be anonymized and shared with auto dealerships, auto manufacturers, appliance manufacturers, medical device manufacturers in order to improve the functionality of an electronic system 102 in relation to the image 114, matched information 122, or output 130 from the AI model 128.

As shown in FIG. 17, a method 200 for assisting a user in understanding a functionality of an electronic system 102 is provided. The method 200 may include the step 202 of providing a database 108 in communication with the application 106, the database 108 including stored information 120 relating to the functionality of the electronic system 102. The method 200 may include the step 204 of capturing an image 114 of a functionality of the electronic system 102 using an image capture device 104. The method 200 may include the step 206 of receiving the image 114 by an application 106 installed on the image capture device 104. The method 200 may include the step 208 of comparing and matching the image 114 to the stored information 120 relating to the functionality of the electronic system 102 of the database 108 using an image recognition module 112 to provide matched information 122. The method 200 may include the step 210 of displaying the matched information 122 using a display 110 in communication with the image recognition module 112.

As shown in FIG. 18, a method 300 for assisting a user in understanding a functionality of an electronic system 102 is provided. The method 300 may include the step 302 of providing a database 108 in communication with the application 106, the database 108 including stored information 120 relating to the functionality of the electronic system 102. The method 300 may include the step 304 of providing an artificial intelligence (AI) module configured to receive the matched information 122 from the image recognition module 112, receive the stored information 120 from the database 108, analyze the matched information 122 and stored information 120, and provide output 130 relating to the analysis of the matched information 122 and stored information 120. The method 300 may include the step 306 of capturing an image 114 of a functionality of the electronic system 102 using an image capture device 104. The method 300 may include the step 308 of receiving the image 114 by an application 106 installed on the image capture device 104. The method 300 may include the step 310 of comparing and matching the image 114 to the stored information 120 relating to the functionality of the electronic system 102 of the database 108 using an image recognition module 112 to provide matched information 122. The method 300 may include the step 312 of receiving the matched information 122 and stored information 120 via the AI model 128. The method 300 may include the step 314 of analyzing the matched information 122 and stored information 120 via the AI model 128. The method 300 may include the step 316 of displaying output 130 on a display 110 relating to the analysis of the matched information 122 and stored information 120.

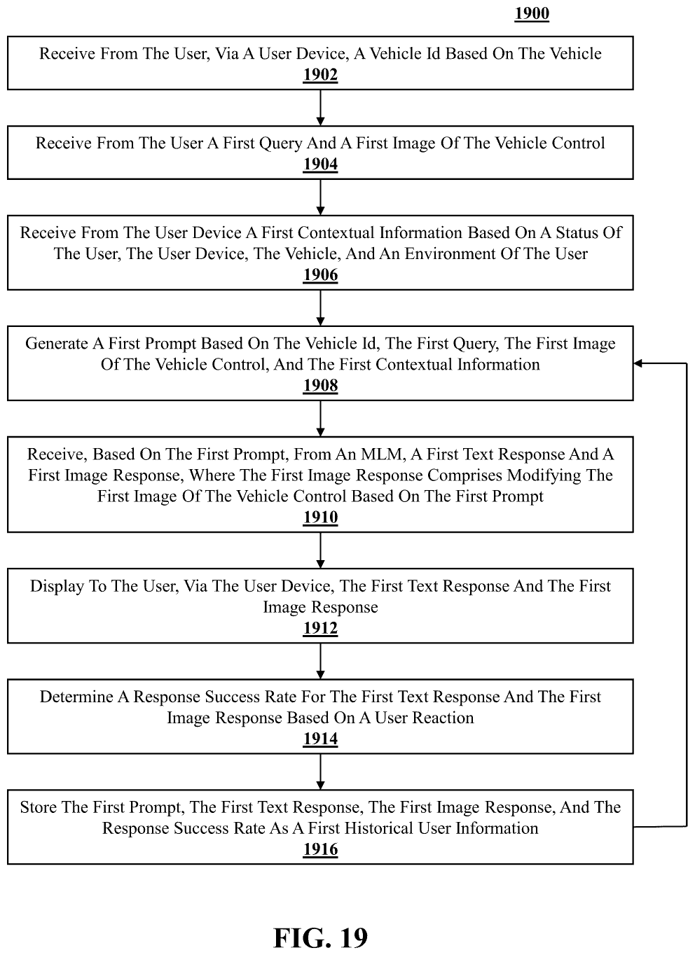

FIG. 19 is a flowchart of an example process 1900 for receiving a query from a user regarding a vehicle control of the electronic system 102 and providing a response based on the user's query, as well as other situationally relevant information. In some implementations, one or more process blocks of FIG. 19 may be performed by the processor 124 of the image capture device 104.

As shown in FIG. 19, process 1900 may include receiving from the user, via a user device (e.g., the image capture device 104), a vehicle ID based on the electronic system 102 (such as a vehicle) (block 1902). For example, the processor 124 may prompt the user, via the image capture device 104, to input identifying information for the electronic system 102, such as for a vehicle (e.g., make, model, year, trim, accessory packages, vehicle identification number (VIN), license plate number). In some embodiments, the user may use the login 132 to access an account associated with the user and having stored the vehicle identification information from prior sessions. In some embodiments the user may be prompted to capture an image of the vehicle which may be used to identify the vehicle using any appropriate form of image recognition such as the image recognition module 112, feature matching (e.g., reverse image search, finding product similarities), pattern and template matching (e.g., identifying QR codes or fixed logos), and AI recognition (e.g., GOOGLE LENS, AMAZON STYLESNAP, PINTEREST LENS, and SNAPCHAT SCAN).

As also shown in FIG. 19, process 1900 may include receiving from the user a first query and a first image of the control of the electronic system 102 (block 1904). For example, the processor 124 may receive from the user a first query and the image 114 (i.e., a first image of the vehicle control), as described above. In some embodiments, the image 114 may comprise multiple controls (such as vehicle controls), and one or more of those controls may be determined to be the target of the user based on the contents of the user query. For example, the user query may indicate the desire to turn on the headlight of a vehicle, which may indicate that controls related to the headlight in the image 114 may be the target of the user. In some embodiments, the user query may include a request to learn how to perform a specific function, use a specific control, or ask a more general question. In some embodiments, only the query or the image may be required from the user.

In some embodiments a vehicle control may be a steering wheel (change vehicle direction), accelerator pedal (increase vehicle speed), brake pedal (slow down or stop vehicle), gear selector / shifter (choose driving mode selection), parking brake (hold vehicle stationary), headlight switch (control exterior lighting), turn signal lever (signal direction change), wiper and washer controls (clear windshield debris), fog light switch (activate low-mounted lights), mirror adjustment controls (position exterior and interior mirrors), horn (warn others of danger), hazard lights (signal roadside emergency), door locks (secure vehicle doors), cruise control (automatically maintain set speed), traction control/stability control switch (disable anti-skid systems), climate control system (set interior temperature and air), defroster (clear window condensation or ice), window controls (raise and lower vehicle windows), seat adjustment (move seat position), fuel door/trunk release (unlock external access), infotainment system (control media and navigation settings), steering wheel audio controls (adjust media volume), instrument cluster (display vehicle performance information), or any available vehicle control.

As further shown in FIG. 19, process 1900 may include receiving from the user device a first contextual information based on a real-time status of the user, the user device, the electronic system 102, and an environment of the user (block 1906). For example, the processor 124 may receive from the image capture device 104 contextual information based on a real-time status of the user which may be relevant to the user query (e.g., location, speed, road elevation, road incline, towing load, time of day), the user device (and the account 134 associated with the user), the vehicle (as identified above), and the environment of the user (e.g., weather conditions, lighting conditions, exterior temperature, in vehicle temperature, and other appropriate environmental conditions).

For example, contextual data may include the current foggy conditions, which may more heavily weigh answers related to the fog light control of the electronic system 102. In some embodiments, when foggy conditions are detected by the user and the electronic system 102 has no fog lights, the advice to avoid using high beams (more significantly during twilight hours) may be weighted more heavily when considering how to respond to the user's query. In a further example, when the exterior temperature of the electronic system 102 is determined to be below freezing, the advice may more heavily weigh explanations for the rear defroster, seat warmer, atmospheric controls, driving dynamics, and other controls associated with cold weather.

In some embodiments, the contextual information may include current gps location (e.g., highway, gravel road), current speed (e.g., 65 mph, stopped), elevation or road incline (e.g., steep incline, steep decline), time of day (e.g., 7:30 am rush hour), and day of the week (e.g., weekend vs. weekday). For example, the detection of the electronic system 102 (such as the vehicle) within a large commercial parking facility may more heavily weigh advice related to the parking assist feature. In a further example, based on historical data indicating a routine weekday commute on a known route, training related to the adaptive cruise control (ACC) system may be given more weight.

As also shown in FIG. 19, process 1900 may include generating a first prompt based on the ID of the electronic system 102 (e.g., a vehicle ID), the first query, the first image of the control, and the first contextual information (block 1908). For example, the processor 124 may generate a first prompt based on the vehicle ID, the first query, the first image of the vehicle control, and the first contextual information, as described above. In some embodiments, the processor 124 may gather the ID of the electronic system 102 and historical information from the account 134 associated with the user. In some embodiments, the processor 124 may be configured to generate an enhanced query for the AI model 128 by utilizing historical user data. The user may initially submit a current multimodal query, which may comprise both an image input (i.e., the first image of the control) and an accompanying text prompt (i.e., the first query). This initial input may be received by the processor 124, which may be configured to access a memory storage associated with the account 134, which may contain a history of the user's past queries, past responses to the user query, and a record of the user's interactions with those outputs.

In some embodiments, the historical information may be analyzed to identify recurring preferences and common contextual factors associated with previous queries. For instance, if a user has consistently submitted prompts relating to cold-weather management (e.g., de-icer, seat warmer, heater, and the like) during specific environmental conditions (e.g., snow, hail, freezing rain, and the like), these elements may be extracted and weighted as preferred parameters. The processor 124 may further identify past dissatisfactions with outputs, allowing the system to refine the prompt to avoid previously rejected outputs.

In some embodiments, the processor 124 may then dynamically generate a refined and enhanced prompt by integrating the identified historical preferences with the elements of the user query. This enhanced prompt may contain additional, unstated context (e.g., appending the current text prompt with “and please more heavily weigh results relating to vehicle controls which apply to the current weather condition”) to the original query. The enhanced prompt may subsequently be transmitted to the MLM, resulting in a more accurate and contextually relevant text output and/or augmented image output that aligns with the user's historical expectations.

As further shown in FIG. 19, process 1900 may include receiving, based on the first prompt, from an MLM, a first text response and a first image response, where the first image response may include modifying the first image of the control based on the first prompt (block 1910). In some embodiments, the first image response may identify and be enhanced with visual cues regarding one or more vehicle control devices identified as being most relevant to the first query. In some embodiments, the first image response may be a series of images that may be viewed as a video having animations overlaid onto the video, where the position and the appearance of the animation indicate a control and a means of use of the control. In some embodiments, the first text response and the first image response may be a coordinate multi-step explanation that answers the user's query. For example, the first text response may be a series of steps that instruct the user how to use the vehicle control to perform a function, and the first image response may be a series of images or videos that visually indicate the respective step outlined in the first text response.

As also shown in FIG. 19, process 1900 may include displaying to the user, via the user device, the first text response and the first image response (block 1912). For example, the processor 124 may display to the user, via the user device, the first text response and the first image response, as described above. In some embodiments, the image capture device 104 may display to the user, via the user interface 116, which may be any of a text-based chat interface, an audio-only driving mode interface, an augmented reality interface, or any appropriate user interface for outputting text and media.

In some embodiments, the user queries about a control's function may be received via the chat interface in three formats: typed text, static image data, or a plurality of images (i.e., video). A clear, descriptive response, detailing the control's purpose and operation, may be output by the AI model 128. This output may be sent back and displayed within the chat interface, making detailed vehicle information easily accessible to the user.

In some embodiments, the user interface 116 may be a dedicated voice interface, configured for the receipt of speech input and the delivery of auditory output, thereby ensuring minimal visual distraction to the driver. User inquiries regarding vehicle control functionality may be received via spoken natural language commands. Concurrently, image and video data of the vehicle cabin controls, captured by internal monitoring systems, may be transmitted to the AI model 128 to provide the necessary visual context. This visual data may be analyzed by computer vision algorithms, which may precisely identify the physical control referenced implicitly or explicitly by the user's voice command. The spoken query and the identified control data are combined into a cohesive prompt. A comprehensive explanation of the control's function, operation, and state is synthesized, and this descriptive information may then be rendered as synthesized speech and communicated back to the user.

In some embodiments, the user interface 116 may be an augmented reality (AR) interface, configured to receive visual data via a camera of the image capture device 104 and to display information as a real-time overlay. Camera feed data, comprising real-time video and image frames of the vehicle cabin, may be transmitted to the AI model 128. Upon receipt, computer vision algorithms may be employed to detect, track, and precisely identify a queried control within the video stream. User inquiries, which may be captured via text or voice input, are combined with the identified control data to form a unified contextual query. A comprehensive explanation of the control's functionality may be synthesized by the AI model 128, and this descriptive information may then be rendered as a graphical overlay, appearing anchored to the physical location of the control within the user's field of view on the display.

As also shown in FIG. 19, process 1900 may include determining a response success rate for the first text response and the first image response based on a user reaction (block 1914). To facilitate continuous learning and model refinement, user feedback may be obtained through both explicit solicitation and implicit behavioral analysis, and may be received by the processor 124. Implicit indicators of response quality may be determined based on subsequent user behavior and changes in the state of the electronic system 102. For instance, a user re-entering the original query but supplying a different image may be interpreted as an indication of low relevance or failure of the preceding response. Conversely, if the vehicle speed transitions from a standstill to in transit shortly after a query is answered, successful comprehension and subsequent control activation may be inferred. All validation data, whether explicit or implicit, is then associated with the original text query, image input, and the generated response, and may be utilized during prompt generation to provide contextual information for future user interactions.

As also shown in FIG. 19, process 1900 may include storing the first prompt, the first text response, the first image response, and the response success rate as a first historical user information (block 1916). The gathered feedback and validation data, both explicit and implicit, may be stored by the processor 124 at the database 108 and may be designated as historical user information. This information is indexed against the user's unique identifier and the specific account 134 to ensure retrieval relevance. The complete record of prior interactions, including the original query, the generated response, and the success/failure validation, may be aggregated within the database 108. For subsequent user inquiries, this historical user information may be retrieved by the processor 124 and may be provided to the AI Model 128 in the prompt. By incorporating this context, the model's response generation process may be further refined, and the content, modality, and complexity of the resulting description may be optimally customized based on past engagement patterns.

Although FIG. 19 shows example blocks of process 1900, in some implementations, process 1900 may include additional blocks, fewer blocks, different blocks, or differently arranged blocks than those depicted in FIG. 19. Additionally, or alternatively, two or more of the blocks of process 1900 may be performed in parallel.

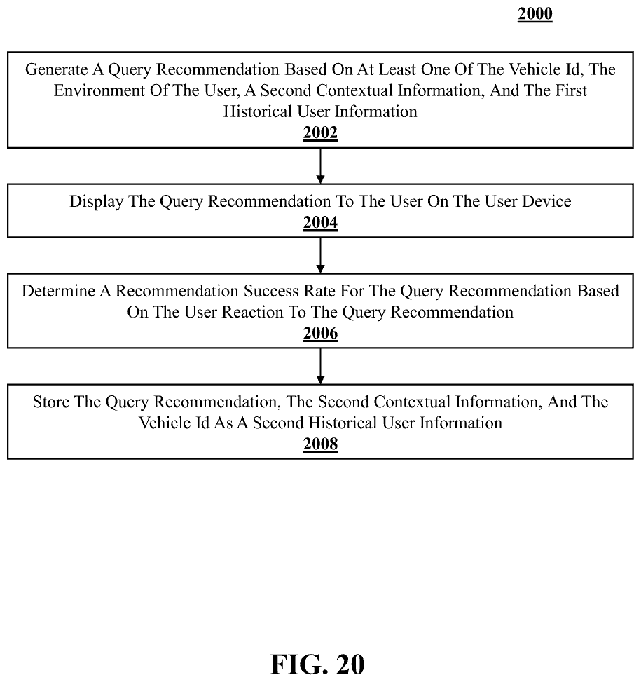

FIG. 20 is a flowchart of an example process 2000 for providing recommendations to the user with relevant control information based on historical information, environmental information, contextual information, environmental information, or any information that may help determine which controls are most relevant to the user. In some implementations, one or more process blocks of FIG. 20 may be performed by the processor 124 of the image capture device 104. In some embodiments, the process 2000 may include additional implementations, such as any single implementation or any combination of implementations described below and/or in connection with one or more other processes described elsewhere herein.

In a first example implementation, process 2000 may include generating a query recommendation based on the ID of the electronic system 102, the environmental information, a second contextual information, and the first historical user information (block 2002). In some embodiments, the vehicle ID may comprise a vehicle (e.g., make, model, year, trim, accessory packages, vehicle identification number (VIN), license plate number). In some embodiments, contextual information based on the real-time status of the user may comprise the user's location, speed, road elevation, road incline, towing load, time of day, and any other appropriate contextual information. In some embodiments, environmental information may comprise weather conditions, lighting conditions, exterior temperature, in-vehicle temperature, and other appropriate environmental conditions. In some embodiments, historical information may include the complete record of prior interactions, including the original query, the generated response, and the success/failure validation

As also shown in FIG. 20, process 2000 may include displaying the query recommendation to the user on the user device (block 2004). In some embodiments, the query recommendation may be provided to the user as a push notification, as an optional query in the user interface 116, as verbal suggestions when the user is driving, or through any other suitable means to deliver the recommendation to the user.

As also shown in FIG. 20, process 2000 may include determining a recommendation success rate for the query recommendation based on the user reaction to the query recommendation (block 2006). In some embodiments, to facilitate continuous learning and model refinement, user feedback may be obtained through both explicit solicitation and implicit behavioral analysis, and may be received by the processor 124. Implicit indicators of recommendation quality may be determined based on subsequent user behavior and changes in the state of the electronic system 102. For instance, a user entering a query slightly different from the recommended one may be interpreted as an indication of low relevance or a failure of the preceding response. Conversely, when the user selects the suggestion and acts on the response, successful comprehension and subsequent control activation may be inferred. All validation data, whether explicit or implicit, is then associated with the original text query, image input, and the generated response, and may be utilized during prompt generation to provide contextual information for future user interactions.

As also shown in FIG. 20, process 2000 may include storing the query recommendation, the second contextual information, and the ID of the electronic system 102 as a second historical user information (block 2008). The gathered feedback and validation data, both explicit and implicit, may be stored by the processor 124 at the database 108 and may be designated as historical user information. This information is indexed against the user's unique identifier and the specific account 134 to ensure retrieval relevance. The complete record of prior interactions, including the original query, the generated response, and the success/failure validation, may be aggregated within the database 108. For subsequent user inquiries, this historical user information may be retrieved by the processor 124 and may be provided to the AI Model 128 in the prompt. By incorporating this context, the model's response generation process may be further refined, and the content, modality, and complexity of the resulting description may be optimally customized based on past engagement patterns.

Although FIG. 20 shows example blocks of process 2000, in some implementations, process 2000 may include additional blocks, fewer blocks, different blocks, or differently arranged blocks than those depicted in FIG. 20. Additionally, or alternatively, two or more of the blocks of process 2000 may be performed in parallel.

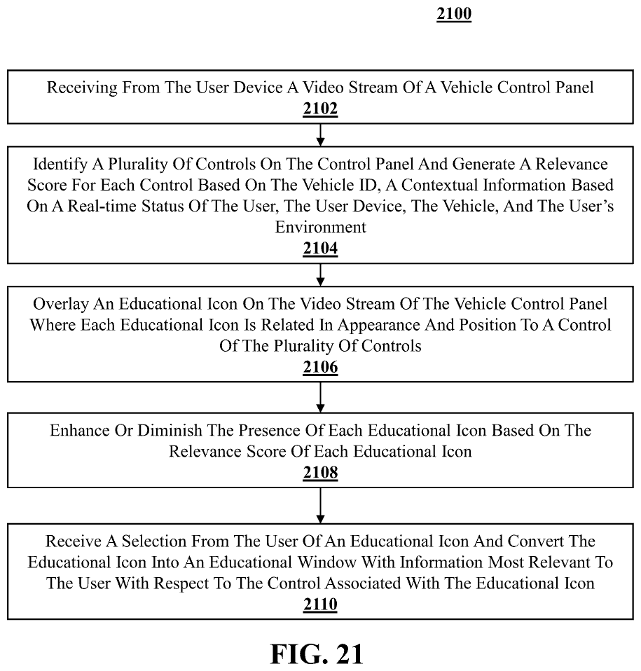

FIG. 21 is a flowchart of an example process 2100 for providing an augmented reality (AR) interface for training a user on vehicle controls. In some implementations, one or more process blocks of FIG. 21 may be performed by the processor 124 of the image capture device 104. In some embodiments, the process 2100 may include additional implementations, such as any single implementation or any combination of implementations described below and/or in connection with one or more other processes described elsewhere herein.

In an example implementation, process 2100 may comprise receiving a video stream of a control panel of the electronic system 102 from the user device (block 2102). In some embodiments, the video stream may be obtained from a camera of the image capture device 104, an internal vehicle camera, a camera from a smart glasses device, or any other available camera. In some implementations, the control panel of the electronic system 102 may be a vehicle dashboard or other control cluster.

As also shown in FIG. 21, process 2100 may include identifying a plurality of controls on the control panel and generating a relevance score for each control based on the ID of the electronic system 102, a contextual information based on a real-time status of the user, the user device, the vehicle, and the user's environment (block 2104). In some embodiments, the video stream, received from the image capture device 104 or a similar sensory source, may be analyzed locally (by the processor 124), in the cloud (by the remote server 118), or by the AI model 128 to identify a plurality of potential controls present within the captured frame. For each identified control, a relevance score may be calculated by the AI Model 128. This score may be determined based on the ID of the electronic system 102 and a comprehensive set of contextual information, including the real-time status of the user, the user's device, the electronic system 102, and the user's environment.

As also shown in FIG. 21, process 2100 may include overlaying an educational icon on the video stream of the vehicle control panel of the electronic system 102, where each educational icon is related in appearance and position to a control of the plurality of controls (block 2106). In some embodiments, a visual overlay may be generated by the processor 124. In some embodiments, the overlay may be received by the user interface 116 and may be superimposed upon the video feed originating from the image capture device 104 or a similar sensory source. In some embodiments, an educational icon may be positioned within the overlay for all or a subset of the identified controls, where the position of the icon is correlated to the spatial coordinates of the corresponding control. Each positioned icon may be configured to provide a visual indication of the function associated with the control. For instance, an icon depicting a snowflake may be associated with an air conditioning control, while a stylized phone handset may be associated with a voice command button.

As also shown in FIG. 21, process 2100 may include enhancing or diminishing the presence of each educational icon based on the relevance score of each educational icon (block 2108). In some embodiments, the visual characteristics of the educational icons may be dynamically adjusted by the processor 124. The calculated relevance score, as determined by the AI model 128, may be utilized to govern the enhancement or diminishment of all or a subset of the identified controls. In some embodiments, the enhancement may be applied to educational icons associated with higher relevance scores, thereby focusing user attention on the most probable control of interest. Conversely, icons corresponding to lower relevance scores may be diminished to minimize visual clutter and distraction. Visual means of enhancement may include, but are not limited to, increasing the icon size, intensifying the icon's color saturation, introducing a pulsating animation, providing a distinct border, or any appropriate means of drawing the user's attention. Diminishment may be achieved by reducing opacity, decreasing the icon size, or rendering the icon in a neutral, subdued color palette, or any other suitable means of reducing the likelihood of drawing the user's attention.

As also shown in FIG. 21, process 2100 may include receiving a user selection of an educational icon and converting the educational icon into an educational window with information most relevant to the user regarding the control associated with the educational icon (block 2110). In some embodiments, in response to the user selecting an educational icon via the AR interface, a detailed educational window may be generated by the processor 124. In some embodiments, the educational icon associated with the user selection is expanded into this window, while the unselected educational icons are diminished or removed from view. In some embodiments, the educational window may be configured to display information most relevant to the user regarding the corresponding vehicle control. The content displayed within the educational window is generated by the AI Model 128 based on the specific ID of the electronic system 102, the user's historical information, and the real-time contextual data. For example, when the user selects the educational icon associated with a climate control knob, the expanded window may display the current temperature setting, the user's historical temperature preference, provide a list of voice commands related to fan speed, and present a graphic illustrating the internal air flow patterns.

Although FIG. 21 shows example blocks of process 2100, in some implementations, process 2100 may include additional blocks, fewer blocks, different blocks, or differently arranged blocks than those depicted in FIG. 21. Additionally, or alternatively, two or more of the blocks of process 2100 may be performed in parallel.

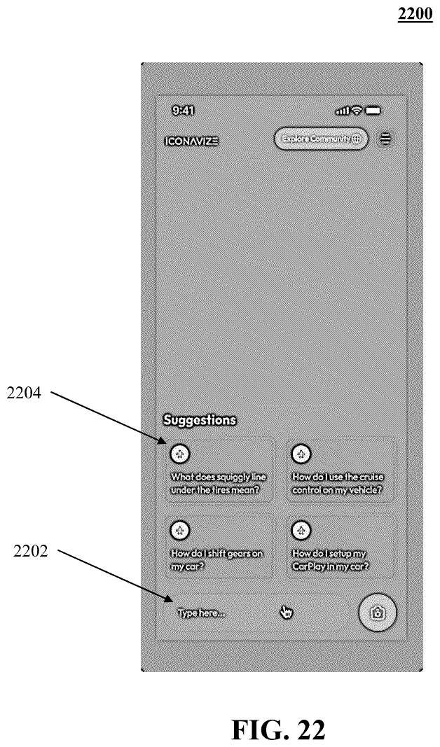

As shown in FIG. 22, an example embodiment of a user interface 2200 for providing the user with query suggestions in a chat-style interface. In some embodiments, the user interface 2200 may be incorporated into the user interface 116. In some embodiments, the user interface 2200 may be configured to comprise an input field 2202 where text queries may be entered. In some embodiments, above the input field 2202, one or more boxes containing suggested queries, such as suggested query 2204, may be displayed before the entry or receipt of any user query. These suggested queries are designed to anticipate common user questions regarding controls and may be dynamically tailored based on at least one of the ID of the electronic system 102, contextual information based on a real-time status of the user, the user device, the electronic system 102, and the user's environment. A selection of one of these suggested query boxes by the user is processed as a valid query input, thereby initiating the multimodal analysis and response generation process described above.

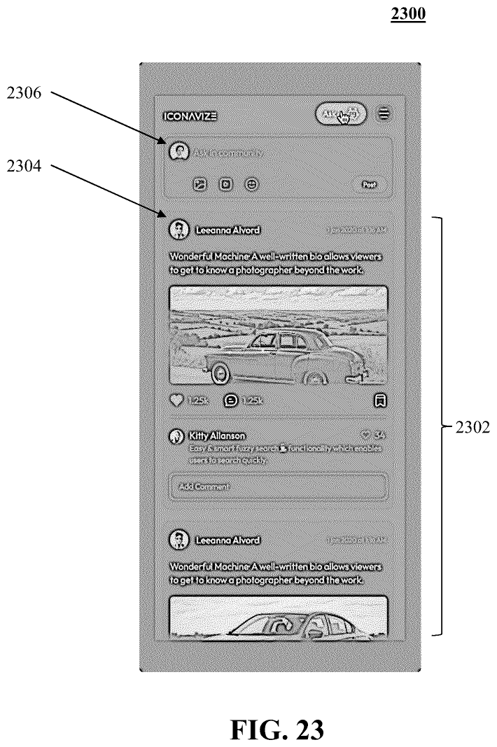

As shown in FIG. 23, an example embodiment of a user interface 2300 for providing a feed 2302 of posts relevant to the user, which unrelated users generate. In some embodiments, the feed 2302 may be a social media-style content feed may be presented to the user via the user interface 116. In some embodiments, the feed 2302 may be populated with content that is generated by unrelated or non-authenticated users of the system, such as the social post 2304. In some embodiments, the content may be filtered and prioritized by the processor 124 and the AI Model 128 based on a plurality of available inputs. In some embodiments, these inputs may include the specific ID of the electronic system 102, and real-time contextual information derived from the status of the user, the user device, the electronic system 102, and the user's environment. In some embodiments, the social post 2304 may comprise user-uploaded images, videos, or text-based descriptions related to controls or functionality. In some embodiments, the user interface 2300 may further include a social post generator 2306, which may provide an input field for the user to generate a social post.

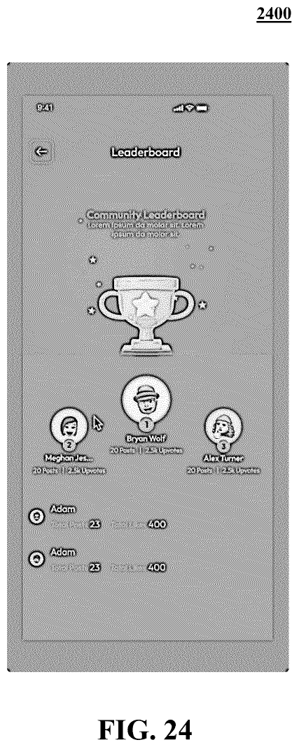

As shown in FIG. 24, an example embodiment of a user interface 2400 for presenting the user points attributed to them based on related social interactions. In some embodiments, the user interface 2400 may be provided for displaying a leaderboard associated with a gamified aspect of the systems and methods described herein. In some embodiments, points may be accrued by users based on social interactions generated by other users and related to content previously contributed by the user, such as uploaded images, videos, comments posted on other posts, or informative text describing a control. In some embodiments, the points are calculated and tracked by the processor 124 based on predetermined metrics of engagement, such as likes, shares, or successful application of the user-contributed content. In some embodiments, the leaderboard may be configured to visually rank users based on their total accrued points, thereby encouraging content generation and user engagement.

Advantageously, the present technology may provide a user-friendly, real-time application that enables a user to gain knowledge about an electronic system and its functionalities. The present technology may address a lack of accessible, on-demand information about electronic features of a device or system by enabling a user to capture an image of a button or icon and receive a detailed description of its purpose and operation. Accordingly, the present technology may reduce the learning curve associated with a new electronic device and enhance user confidence when operating the device or system. Additionally, the ability of the system and associated database to adapt to different electronic devices and update information enables a user to receive accurate and relevant information specific to the electronic device. By eliminating the need for direct internal connectivity, this technology offers significant advantages in terms of flexibility and accessibility. Users can utilize the application on any vehicle they drive, without requiring pre-established connections or additional hardware. This also enables broader adoption across various industries, allowing individuals to interpret device status indicators from an array of systems that may not have been designed with smart integration in mind. Consequently, the present technology enhances usability, providing a seamless and universal approach to understanding and responding to visual alerts across multiple domains.

### EXAMPLES

Example embodiments of the present technology are provided with reference to the FIGS. 1-18 figures enclosed herewith.

### Example 1: New Vehicle Dashboard Button Identification

A user may be driving a new or unfamiliar vehicle and notice an unfamiliar button on the dashboard. The user may open the application on a image capture device and capture an image of the button using the image capture device. Capturing the image may be done without access the vehicle's Bluetooth or OBD-II adaptor. The application and system may then process the image and identify the button as a control, for example, a rear fog light control. The display may then show and/or communicate information, such as “this button switches the rear fog light on/off. Rear fog lights may be used in conditions of very poor visibility to make your vehicle more visible to other drivers from behind.”

The user may then understand a function of the button, and may or may not activate the rear fog light as the current weather conditions may or may not require. In particular, the system may quickly provide relevant information about a vehicle control, thus enhancing the understanding of a user and promoting safer driving practices.

### Example 2: Older Vehicle Dashboard Button Identification

A user may be driving an older model vehicle and notice an unfamiliar button on the dashboard. The vehicle lacks modern connectivity features and presents simple ‘back-lit’ icons on the dashboard. While driving, the user notices a warning light appear on the dashboard. Without an onboard diagnostic system, the user relies on the application to identify the symbol as a coolant temperature warning. The diagnostics without Bluetooth capability or an OBD-II adaptor. The application and system may then process the image and identify the button as a control, for example, a rear fog light control. The application then advises the user to check his coolant levels and provides instructions on how to safely add coolant, preventing potential engine overheating.

### Example 3: Home Thermostat Control

A homeowner may have installed a new thermostat but is unsure how to operate the features. The homeowner may open the application on the image capture device and capture an image of the thermostat display. The application may process the image and identify the thermostat as a smart home device. The display may then show information, such as “this is the main control panel. The large number in the center is the current temperature. The up and down arrows on the right show a target temperature, and the icon on the left toggles between heating and cooling modes.” Additionally, the application may include energy-saving features and other information as appropriately desired.

### Example 4: Home Security System Setup

A homeowner may configure a home security system but is confused by the various sensors and control panel. The user may use the application of the image capture device to capture an image of the main control panel. The system may then analyze the image in order to identify the device as a home security control panel. The application may then display and/or communicate information, such as “this the main control panel of the home security system. The numbered keypad is used to arm and disarm the system. To arm the system when leaving the house, press the ‘Away’ button followed by your 4-digit code. To arm the system while at home, press the ‘Stay’ button followed by your code,” or other appropriately desired information.”

### Example 5: Portable Medical Device Operation

A patient may have been prescribed a portable oxygen concentrator for home use but may be unsure how to operate and maintain the device. The system may identify the device and display information utilizing the user interface, the image capture device, and the database such as describe above upon identification, the system may provide output one the display for the user, for example, a message such as “this is a portable oxygen concentrator”. The large dial in the center adjusts the oxygen flow rate. The button on the left turns the device on and off. The battery indicator on the right shows the remaining battery life.”

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

### CLAUSES I:

Example Clause A: A system for assisting a user in understanding a functionality of an electronic system, used with an image capture device, may include: an application installed on the image capture device, the application configured to receive the image from the image capture device; a database in communication with the application, the database including stored information relating to the functionality of the electronic system; an image recognition module configured to compare and match the image to the stored information and provide matched information; and a display in communication with the image recognition module, the display configured to show the matched information.

Example Clause B: The system of Example Clause A, further may include: an artificial intelligence (AI) module configured to receive the matched information from the image recognition module, receive the stored information from the database, analyze the matched information and stored information, and provide output relating to the analysis of the matched information and stored information.

Example Clause C: A method for assisting a user in understanding a functionality of an electronic system, used with an image capture device, may include: providing a database in communication with the application, the database including stored information relating to the functionality of the electronic system; capturing an image of a functionality of the electronic system using an image capture device; receiving the image by an application installed on the image capture device; comparing and matching the image to the stored information relating to the functionality of the electronic system of the database using an image recognition module to provide matched information; and displaying the matched information using a display in communication with the image recognition module.

Example Clause D: The method of Example Clause C, further may include: providing an artificial intelligence (AI) module configured to receive the matched information from the image recognition module, receive the stored information from the database, analyze the matched information and stored information, and provide output relating to the analysis of the matched information and stored information. Receiving the matched information and stored information via the AI module; analyzing the matched information and stored information via the AI module; and displaying output on a display relating to the analysis of the matched information and stored information.

Example Clause E: A device for assisting a user in understanding a functionality of an electronic system or an electronic device, as shown and described in the figures and specification provided herewith.

### CLAUSES II:

Example Clause A: A method for answering inquiries from a user regarding a vehicle control of a vehicle, the method may include: receiving from the user, via a user device, a vehicle ID based on the vehicle; receiving from the user a first query and a first image of the vehicle control; receiving from the user device a first contextual information based on a real-time status of the user, the user device, the vehicle, and an environment of the user; generating a first prompt based on the vehicle ID, the first query, the first image of the vehicle control, and the first contextual information; receiving, based on the first prompt, from an MLM, a first text response and a first image response, where the first image response may include modifying the first image of the vehicle control based on the first prompt; and displaying to the user, via the user device, the first text response and the first image response.

Example Clause B: The method of Example Clause A, further may include: determining a response success rate for the first text response and the first image response based on a user reaction; and storing the first prompt, the first text response, the first image response, and the response success rate as a first historical user information.

Example Clause C: The method of Example Clause A or Example Clause B, further may include: generating a query recommendation based on the vehicle ID, a second contextual information, and the first historical user information; displaying the query recommendation to the user on the user device; determining a recommendation success rate for the query recommendation based on the user reaction to the query recommendation; and storing the query recommendation, the second contextual information, and the vehicle ID as a second historical user information.

Example Clause D: The method of any one of Example Clauses A-C, further may include: receiving from the user a second query and a second image of the vehicle control; receiving from the user device a second contextual information based on the real-time status of the user, the user device, the vehicle, and the environment; generating a second prompt based on the vehicle ID, the second query, the second image of the vehicle control, the second contextual information, and the first historical user information; receiving, based on the second prompt, from the MLM, a second text response and a second image response, where the second image response may include modifying the second image of the vehicle control based on the second prompt; and displaying to the user, via the user device, the second text response and the second image response.

Example Clause E: The method of any one of Example Clauses A-D, where, in response to the user device determining that the user is driving the vehicle, receiving the first query as speech from the user.

Example Clause F: The method of any one of Example Clauses A-E, where the first prompt includes instructions that direct the MLM to generate a plurality of augmented images based on the first image of the vehicle control.

Example Clause G: The method of any one of Example Clauses A-F, further may include receiving a length of time the user has used the vehicle and including in the first prompt the length of time the user has used the vehicle to provide additional context.

Example Clause H: The method of any one of Example Clauses A-G, further may include, in response to determining that a weather event is occurring based on the first contextual information, including a relevance of the vehicle control to the weather event in at least one of the first text response and the first image response.

Example Clause I: A device for answering inquiries from a user regarding a vehicle control of a vehicle, the device may include: a storage; and a processor executing program instructions stored in the storage and being configured to: receive from the user, via the device, a vehicle ID based on the vehicle; receive from the user a first query and a first image of the vehicle control; receive from the device a first contextual information based on a real-time status of the user, the device, the vehicle, and an environment of the user; generate a first prompt based on the vehicle ID, the first query, the first image of the vehicle control, and the first contextual information; receive, based on the first prompt, from an MLM, a first text response and a first image response, where the first image response may include modifying the first image of the vehicle control based on the first prompt; and display to the user, via the device, the first text response and the first image response.

Example Clause J: The device of Example Clause I, where the processor is further configured to: determine a response success rate for the first text response and the first image response based on a user reaction; and store the first prompt, the first text response, the first image response, and the response success rate as a first historical user information.

Example Clause K: The device of Example Clause I or Example Clause J, where the processor is further configured to: generate a query recommendation based on the vehicle ID, a second contextual information, and the first historical user information; display the query recommendation to the user on the device; determine a recommendation success rate for the query recommendation based on the user reaction to the query recommendation; and store the query recommendation, the second contextual information, and the vehicle ID as a second historical user information.

Example Clause L: The device of any one of Example Clauses I-K, where the processor is further configured to: receive from the user a second query and a second image of the vehicle control; receive from the device a second contextual information based on the real-time status of the user, the device, the vehicle, and the environment; generate a second prompt based on the vehicle ID, the second query, the second image of the vehicle control, the second contextual information, and the first historical user information; receive, based on the second prompt, from the MLM, a second text response and a second image response, where the second image response may include modifying the second image of the vehicle control based on the second prompt; and display to the user, via the device, the second text response and the second image response.

Example Clause M: The device of any one of Example Clauses I-L, where, in response to the device determining that the user is driving the vehicle, receiving the first query as speech from the user.

Example Clause N: The device of any one of Example Clauses I-M, where the first prompt includes instructions that direct the MLM to generate a plurality of augmented images based on the first image of the vehicle control.

Example Clause O: A system for answering inquiries from a user regarding a vehicle control of a vehicle, the system may include one or more processors configured to: receive from the user, via a user device, a vehicle ID based on the vehicle; receive from the user a first query and a first image of the vehicle control; receive from the user device a first contextual information based on a real-time status of the user, the user device, the vehicle, and an environment of the user; generate a first prompt based on the vehicle ID, the first query, the first image of the vehicle control, and the first contextual information; receive, based on the first prompt, from an MLM, a first text response and a first image response, where the first image response may include modifying the first image of the vehicle control based on the first prompt; and display to the user, via the user device, the first text response and the first image response.

Example Clause P: The system of Example Clause O, where the one or more processors are further configured to: determine a response success rate for the first text response and the first image response based on a user reaction; and store the first prompt, the first text response, the first image response, and the response success rate as a first historical user information.

Example Clause Q: The system of Example Clause O or Example Clause P, where the one or more processors are further configured to: generate a query recommendation based on the vehicle ID, a second contextual information, and the first historical user information; display the query recommendation to the user on the user device; determine a recommendation success rate for the query recommendation based on the user reaction to the query recommendation; and store the query recommendation, the second contextual information, and the vehicle ID as a second historical user information.

Example Clause R: The system of any one of Example Clauses O-Q, where the one or more processors are further configured to: receive from the user a second query and a second image of the vehicle control; receive from the user device a second contextual information based on the real-time status of the user, the user device, the vehicle, and the environment; generate a second prompt based on the vehicle ID, the second query, the second image of the vehicle control, the second contextual information, and the first historical user information; receive, based on the second prompt, from the MLM, a second text response and a second image response, where the second image response may include modifying the second image of the vehicle control based on the second prompt; and display to the user, via the user device, the second text response and the second image response.

Example Clause S: The system of any one of Example Clauses O-R, where the one or more processors are further configured to: receive a length of time the user has used the vehicle and include in the first prompt the length of time the user has used the vehicle to provide additional context.

Example Clause T: The system of any one of Example Clauses O-S, where the one or more processors are further configured to, in response to determining that a weather event is occurring based on the first contextual information, including a relevance of the vehicle control to the weather event in at least one of the first text response and the first image response.

Several embodiments have been discussed in the foregoing description. However, the embodiments discussed herein are not intended to be exhaustive or limit the invention to any particular form. The terminology which has been used is intended to be in the nature of words of description rather than of limitation. Many modifications and variations are possible in light of the above teachings and the invention may be practiced otherwise than as specifically described.

What is claimed is:

1. A method for answering inquiries from a user regarding a vehicle control of a vehicle,
the method comprising:
receiving from the user, via a user device, a vehicle ID based on the vehicle;
receiving from the user a first query and a first image of the vehicle control;
receiving from the user device a first contextual information based on a real-time status of the user, the user device, the vehicle, and an environment of the user;
generating a first prompt based on the vehicle ID, the first query, the first image of the vehicle control, and the first contextual information;
receiving, based on the first prompt, from an MLM, a first text response and a first image response, where the first image response comprises modifying the first image of the vehicle control based on the first prompt; and
displaying to the user, via the user device, the first text response and the first image response.

2. The method of claim 1, further comprising:
determining a response success rate for the first text response and the first image response based on a user reaction; and
storing the first prompt, the first text response, the first image response, and the response success rate as a first historical user information.

3. The method of claim 2, further comprising:
generating a query recommendation based on the vehicle ID, a second contextual information, and the first historical user information;
displaying the query recommendation to the user on the user device;
determining a recommendation success rate for the query recommendation based on the user reaction to the query recommendation; and
storing the query recommendation, the second contextual information, and the vehicle ID as a second historical user information.

4. The method of claim 2, further comprising:
receiving from the user a second query and a second image of the vehicle control;
receiving from the user device a second contextual information based on the real-time status of the user, the user device, the vehicle, and the environment;
generating a second prompt based on the vehicle ID, the second query, the second image of the vehicle control, the second contextual information, and the first historical user information;
receiving, based on the second prompt, from the MLM, a second text response and a second image response, where the second image response comprises modifying the second image of the vehicle control based on the second prompt; and
displaying to the user, via the user device, the second text response and the second image response.

5. The method of claim 1, wherein, in response to the user device determining that the user is driving the vehicle, receiving the first query as speech from the user.

6. The method of claim 1, wherein the first prompt includes instructions that direct the MLM to generate a plurality of augmented images based on the first image of the vehicle control.

7. The method of claim 1, further comprising receiving a length of time the user has used the vehicle and including in the first prompt the length of time the user has used the vehicle to provide additional context.

8. The method of claim 1, further comprising, in response to determining that a weather event is occurring based on the first contextual information, including a relevance of the vehicle control to the weather event in at least one of the first text response and the first image response.

9. A device for answering inquiries from a user regarding a vehicle control of a vehicle, the device comprising:
a storage; and
a processor executing program instructions stored in the storage and being configured to:
receive from the user, via the device, a vehicle ID based on the vehicle;
receive from the user a first query and a first image of the vehicle control;
receive from the device a first contextual information based on a real-time status of the user, the device, the vehicle, and an environment of the user;
generate a first prompt based on the vehicle ID, the first query, the first image of the vehicle control, and the first contextual information;
receive, based on the first prompt, from an MLM, a first text response and a first image response, where the first image response comprises modifying the first image of the vehicle control based on the first prompt; and
display to the user, via the device, the first text response and the first image response.

10. The device of claim 9, wherein the processor is further configured to:
determine a response success rate for the first text response and the first image response based on a user reaction; and
store the first prompt, the first text response, the first image response, and the response success rate as a first historical user information.

11. The device of claim 10, wherein the processor is further configured to:
generate a query recommendation based on the vehicle ID, a second contextual information, and the first historical user information;
display the query recommendation to the user on the device;
determine a recommendation success rate for the query recommendation based on the user reaction to the query recommendation; and
store the query recommendation, the second contextual information, and the vehicle ID as a second historical user information.

12. The device of claim 10, wherein the processor is further configured to:
receive from the user a second query and a second image of the vehicle control;
receive from the device a second contextual information based on the real-time status of the user, the device, the vehicle, and the environment;
generate a second prompt based on the vehicle ID, the second query, the second image of the vehicle control, the second contextual information, and the first historical user information;
receive, based on the second prompt, from the MLM, a second text response and a second image response, where the second image response comprises modifying the second image of the vehicle control based on the second prompt; and
display to the user, via the device, the second text response and the second image response.

13. The device of claim 9, wherein, in response to the device determining that the user is driving the vehicle, receiving the first query as speech from the user.

14. The device of claim 9, wherein the first prompt includes instructions that direct the MLM to generate a plurality of augmented images based on the first image of the vehicle control.

15. A system for answering inquiries from a user regarding a vehicle control of a vehicle, the system comprising one or more processors configured to:
receive from the user, via a user device, a vehicle ID based on the vehicle;
receive from the user a first query and a first image of the vehicle control;
receive from the user device a first contextual information based on a real-time status of the user, the user device, the vehicle, and an environment of the user;
generate a first prompt based on the vehicle ID, the first query, the first image of the vehicle control, and the first contextual information;
receive, based on the first prompt, from an MLM, a first text response and a first image response, where the first image response comprises modifying the first image of the vehicle control based on the first prompt; and
display to the user, via the user device, the first text response and the first image response.

16. The system of claim 15, wherein the one or more processors are further configured to:
determine a response success rate for the first text response and the first image response based on a user reaction; and
store the first prompt, the first text response, the first image response, and the response success rate as a first historical user information.

17. The system of claim 16, wherein the one or more processors are further configured to:
generate a query recommendation based on the vehicle ID, a second contextual information, and the first historical user information;
display the query recommendation to the user on the user device;
determine a recommendation success rate for the query recommendation based on the user reaction to the query recommendation; and
store the query recommendation, the second contextual information, and the vehicle ID as a second historical user information.

18. The system of claim 16, wherein the one or more processors are further configured to:
receive from the user a second query and a second image of the vehicle control;
receive from the user device a second contextual information based on the real-time status of the user, the user device, the vehicle, and the environment;
generate a second prompt based on the vehicle ID, the second query, the second image of the vehicle control, the second contextual information, and the first historical user information;
receive, based on the second prompt, from the MLM, a second text response and a second image response, where the second image response comprises modifying the second image of the vehicle control based on the second prompt; and
display to the user, via the user device, the second text response and the second image response.

19. The system of claim 15, wherein the one or more processors are further configured to:
receive a length of time the user has used the vehicle and include in the first prompt the length of time the user has used the vehicle to provide additional context.

20. The system of claim 15, wherein the one or more processors are further configured to, in response to determining that a weather event is occurring based on the first contextual information, including a relevance of the vehicle control to the weather event in at least one of the first text response and the first image response.
